(19) United States
(12) Patent Application Publication
(10) Pub. No.: US 2020/0075018 A1
(43) Pub. Date: Mar. 5, 2020

(54) CONTROL METHOD OF MULTI VOICE ASSISTANTS

(71) Applicant: COMPAL ELECTRONICS, INC., Taipei City (TW)

(72) Inventor: Yi-Ching Chen, Taipei City (TW)

(21) Appl. No.: 16/169,737

(22) Filed: Oct. 24, 2018

(30) Foreign Application Priority Data
Aug. 28, 2018 (TW) 107129981

(51) Int. Cl. G10L 15/32; G10L 15/22

(52) U.S. Cl. CPC G10L 15/32; G10L 2015/223; G10L 2015/225; G10L 15/22

(57) ABSTRACT

A control method of multi voice assistants includes steps of (a) providing an electronic device equipped with a plurality of voice assistants, (b) activating a plurality of recognition engines corresponded to the voice assistants for making the electronic device enter a listening mode to receive at least a voice object, (c) analyzing the voice object and selecting a corresponded recognition engine from the recognition engines according to an analysis result, (d) judging whether a conversation is over, (e) modifying a plurality of recognition thresholds corresponded to the recognition engines, and (f) turning off the non-corresponded recognition engines. When the judgment of the step (d) is TRUE, the step (b) is performed after the step (d). When the judgment of the step (d) is FALSE, the step (e) and the step (f) are sequentially performed after the step (d). Therefore, the user experiences are enhanced, and the wait time is reduced.

### CROSS-REFERENCE TO RELATED APPLICATION

This application claims priority from Taiwan Patent Application No. 107129981, filed on Aug. 28, 2018, the entire contents of which are incorporated herein by reference for all purposes.

### FIELD OF THE INVENTION

The present invention relates to a control method, and more particularly to a control method of multi voice assistants applied to a smart electronic device.

### BACKGROUND OF THE INVENTION

In recent years, accompanying with the growing of the smart electronic devices, smart home appliances and smart homes have also been proposed and applied. Smart speakers have gradually become popular in general households and small stores. Being distinct from conventional speakers, smart speakers are usually equipped with voice assistants (e.g. Amazon's Alexa) to provide users with services having multiple functions through conversations.

With the continuous improvement of the technology of voice recognition and voice assistant, a plurality of different voice assistants can be installed simultaneously in a single electronic device to provide user services having different functions. For example, a voice assistant directly integrated with the system can provide functions related to system aspects such as time, date, calendar, and alarm clock. A voice assistant combined with a specific software or function can provide specific data search, shopping, restaurant-booking, ticket-ordering, and other functions or services.

However, conventional electronic devices installed with multiple voice assistants require additional switching commands when switching to different voice assistants to perform corresponding functions or services. Please refer to FIG. 1. FIG. 1 schematically illustrates a simplified flow chart showing a control method of multi voice assistants of prior art. As shown in FIG. 1, when the electronic device is in an idle state and a wake command and a general utterance is inputted with voice of the user, the electronic device is woken up and the content of the utterance is transmitted to the first voice assistant combined with the system, and the relevant functions mentioned in the utterance is performed or the relevant services are provided. However, the functions and services that each voice assistant can provide are not the same. Therefore, when the user wants to use the function or service that the first voice assistant cannot provide, even though the user performs voice input in the foregoing manner, the first voice assistant will be woken up, but will not perform any functions. At this time, the user must input the wake command and the switch command with voice. After the electronic device responds to confirm that the second voice assistant has been enabled, the general utterance is inputted through voice input of the user, and the relevant functions mentioned in the utterance is finally performed or the relevant services are finally provided by the second voice assistant.

That is, the user must remember the relationships between the functions/services and the voice assistants. The switch command has to be indeed inputted, and then the confirmation of switching voice assistants responded by the electronic device has to be waited, the desired functions or services are finally accomplished through the appropriated voice assistant. Not only the user experiences are bad, but also the operation is not intuitive and the time is wasted. More conversations may cause more recognition errors, which is too inconvenient for the user to operate with the voice assistants.

Therefore, there is a need of providing a control method of multi voice assistants distinct from the prior art in order to solve the above drawbacks.

### SUMMARY OF THE INVENTION

Some embodiments of the present invention are to provide a control method of multi voice assistants in order to overcome at least one of the above-mentioned drawbacks encountered by the prior arts.

The present invention provides a control method of multi voice assistants. By analyzing the voice object and directly selecting the corresponded recognition engine, the corresponded voice assistant can be directly called to provide service, so that the user may use the electronic device through more intuitive conversations, thereby enhancing the user experiences and reducing the wait time.

The present invention also provides a control method of multi voice assistants. Through the application of the arbitrator, the recognition policy and the listener, not only all the recognition engines can be early re-activated to recognize when the wait time is longer than a preset time, but also the corresponded recognition engine can be selected according to the content inputted from the listener to the arbitrator, so that the wait time of the user is reduced and the redundant conversation is avoided.

In accordance with an aspect of the present invention, there is provided a control method of multi voice assistants. The control method of multi voice assistants includes steps of (a) providing an electronic device equipped with a plurality of voice assistants, (b) activating a plurality of recognition engines corresponded to the voice assistants for making the electronic device enter a listening mode to receive at least a voice object, (c) analyzing the voice object and selecting a corresponded recognition engine from the recognition engines according to an analysis result, (d) judging whether a conversation is over, (e) modifying a plurality of recognition thresholds corresponded to the recognition engines, and (f) turning off the non-corresponded recognition engines. When the judgment of the step (d) is TRUE, the step (b) is performed after the step (d). When the judgment of the step (d) is FALSE, the step (e) and the step (f) are sequentially performed after the step (d).

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a simplified flow chart showing a control method of multi voice assistants of prior art;

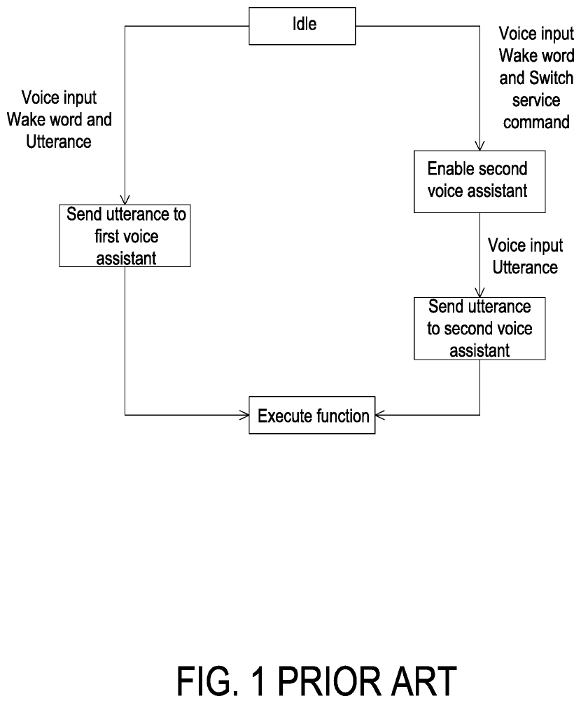

FIG. 2 schematically illustrates the flow chart of a control method of multi voice assistants according to an embodiment of the present invention;

FIG. 3 schematically illustrates a control method of multi voice assistants according to another embodiment of the present invention;

FIG. 4 schematically illustrates the configuration of an electronic device applied to a control method of multi voice assistants of the present invention;

FIG. 5 schematically illustrates the interaction relations of an arbitrator of a control method of multi voice assistants of the present invention; and

FIG. 6 schematically illustrates the operation states of an arbitrator of a control method of multi voice assistants of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

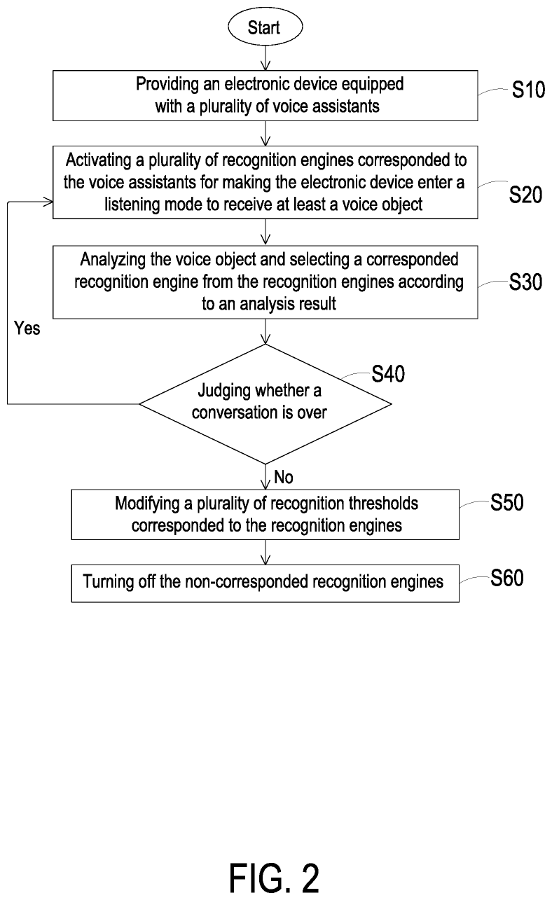

Please refer to FIG. 2. FIG. 2 schematically illustrates the flow chart of a control method of multi voice assistants according to an embodiment of the present invention. As shown in FIG. 2, a control method of multi voice assistants of the present invention includes steps as following. At first, as shown in step S10, providing an electronic device equipped with a plurality of voice assistants. The electronic device can be but not limited to a smart speaker, a smart phone or a control device in a smart home. Next, as shown in step S20, activating a plurality of recognition engines corresponded to the voice assistants for making the electronic device enter a listening mode to receive at least a voice object. The voice object may include a wake command and an utterance, but not limited thereto. In some embodiments, each recognition engine is utilized to recognize the relevant wake commands and/or utterances containing the action instructions for a corresponded voice assistant. For example, “setting the alert clock” is recognized by a first recognition engine, and a first voice assistant provides the function or service of the alert clock, and “purchasing some product” is recognized by a second recognition engine, and a second voice assistant uses an application to purchase that product. It should be noted that if the functions or the services provided by each voice assistant are distinct from each other, the name of each functions or each services may be directly utilized as the wake commands in the control method of multi voice assistants of the present invention, but not limited thereto.

Next, as shown in step S30, analyzing the voice object and selecting a corresponded recognition engine from the recognition engines according to an analysis result. Then, as shown in step S40, judging whether a conversation is over. When the judgment of the step S40 is TRUE (i.e. the conversation is over), the step S20 is re-performed after the step S40. When the judgment of the step S40 is FALSE (i.e. the conversation is not over), at least the step S50 and the step S60 are sequentially performed after the step S40. It should be noted that the conversation mentioned here is a conversation between a user and an electronic device. Step S50 is a step of modifying a plurality of recognition thresholds corresponded to the recognition engines. Step S60 is a step of turning off the non-corresponded recognition engines. By analyzing the voice object and directly selecting the corresponded recognition engine, the corresponded voice assistant can be directly called to provide service, so that the user may use the electronic device through more intuitive conversations, thereby enhancing the user experiences and reducing the wait time.

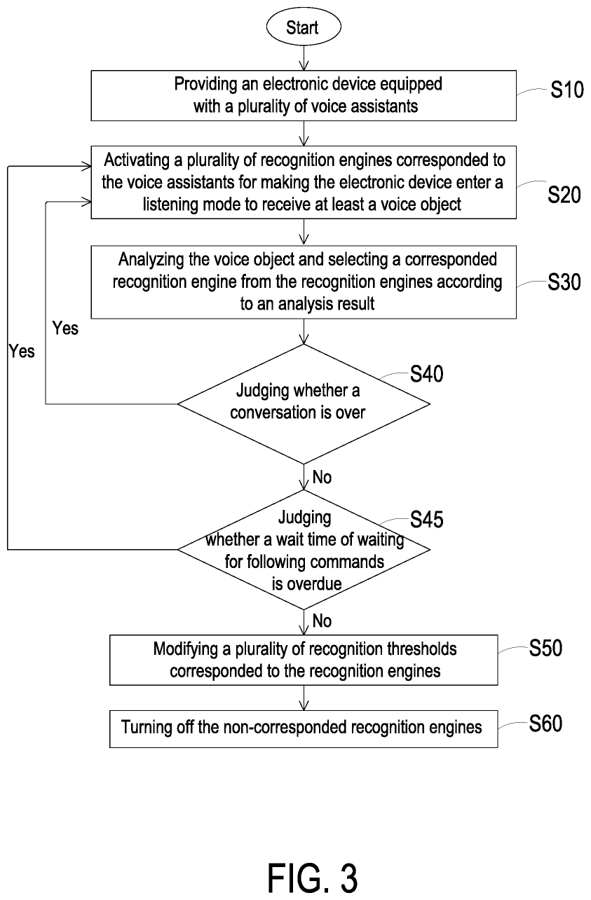

Please refer to FIG. 3. FIG. 3 schematically illustrates a control method of multi voice assistants according to another embodiment of the present invention. As shown in FIG. 3, the control method of multi voice assistants of the present invention further includes a step S45, after the step S40, of judging whether a wait time of waiting for following commands is overdue. When the judgment of the step S40 is FALSE (i.e. the conversation is not over), the step S45, the step S50 and the step S60 are sequentially performed after the step S40. When the judgment of the step S45 is TRUE (i.e. the wait time is overdue), the step S20 is performed after the step S45. When the judgment of the step S45 is FALSE (i.e. the wait time is not overdue), the step S50 and the step S60 are performed after the step S45.

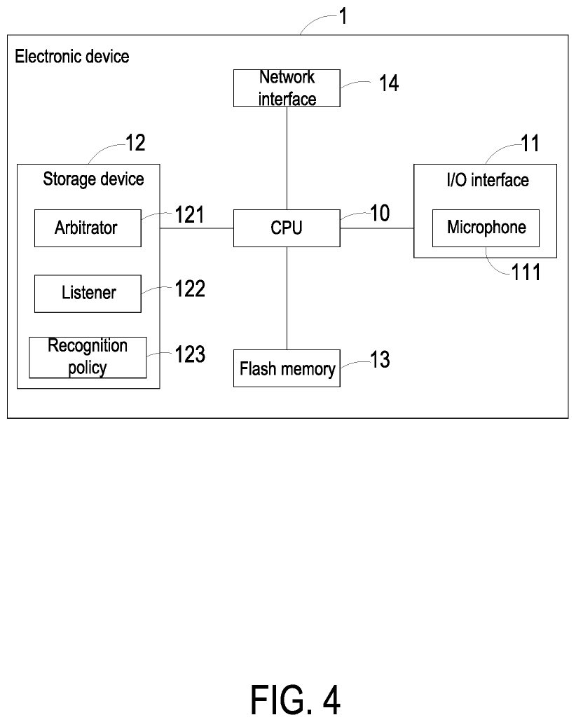

Please refer to FIG. 4. FIG. 4 schematically illustrates the configuration of an electronic device applied to a control method of multi voice assistants of the present invention. As shown in FIG. 4, the fundamental structure of an electronic device 1 that may implement the control method of multi voice assistants of the present invention includes a CPU (Central Processing Unit) 10, a I/O (Input and Output) interface 11, a storage device 12, a flash memory 13 and a network interface 14. The I/O interface 11, the storage device 12, the flash memory 13 and the network interface 14 are connected with the CPU 10. The CPU 10 is configured to control the I/O interface 11, the storage device 12, the flash memory 13, the network interface 14, and the entire operation of the electronic device 1. The I/O interface 11 includes a microphone 111. The microphone 111 is provided to the user for voice input, but not limited thereto. The electronic device 1 may further include a listener. In some embodiments, the listener can be a software unit stored in the storage device 12. For example, the storage device 12 shown in FIG. 4 may include an arbitrator 121, a listener 122 and a recognition policy 123. The arbitrator 121 and the listener 122 herein are software units, which can be stored or integrated in the storage device 12. Certainly, the arbitrator 121 and the listener 122 can also be hardware units (e.g. an arbitrator chip and a listener chip) that are independent from the storage device 12. The recognition policy 123 is preloaded by the storage device 12, and the recognition policy 123 is preferred to be existed as a database, but not limited thereto. The flash memory 13 may be a volatile space such as a main memory or a random access memory (RAM), or may be an external storage or a system disk. The network interface 14 is a wired network interface or a wireless network interface that provides the connection for the electronic device to connect to a network, such as a local area network or the Internet.

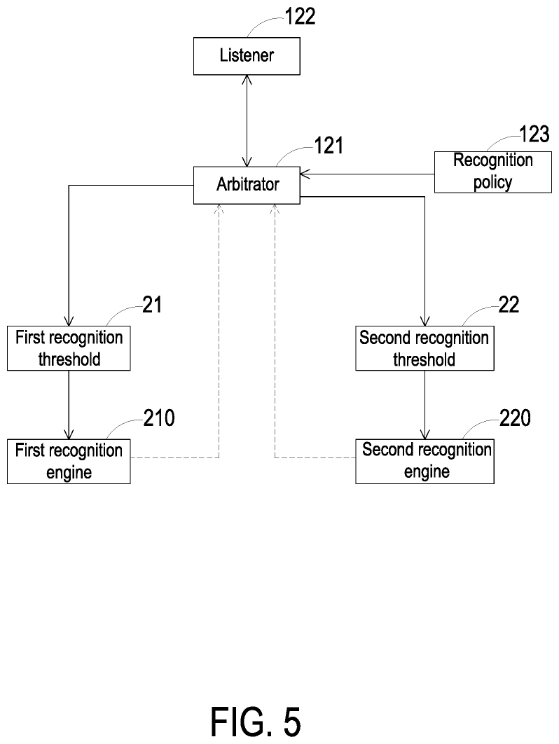

Please refer to FIG. 2, FIG. 3, FIG. 4 and FIG. 5. FIG. 5 schematically illustrates the interaction relations of an arbitrator of a control method of multi voice assistants of the present invention. As shown in FIGS. 2-5, when the electronic device 1 enters the listening mode in the step S20, the arbitrator 121 enters a listen state from an idle state. In addition, the arbitrator 121 analyzes the voice object inputted by the listener 122 according to the recognition policy 123 to obtain the analysis result in the step S30. On the other hand, the judgment of the step S40 is judged by the arbitrator 121 according to an input from the listener 122. When the input is a notification of end of the conversation, the judgment of the step S40 is TRUE. Similarly, the judgment of the step S45 is judged by the arbitrator 121 according to the recognition policy 123. When the wait time is larger than a preset time preset in the recognition policy 123, the judgment of the step S45 is TRUE. For example, if the preset time is 1 second, when the wait time of waiting for the following commands is longer that 1 second, the step S45 determines that the wait time is overdue.

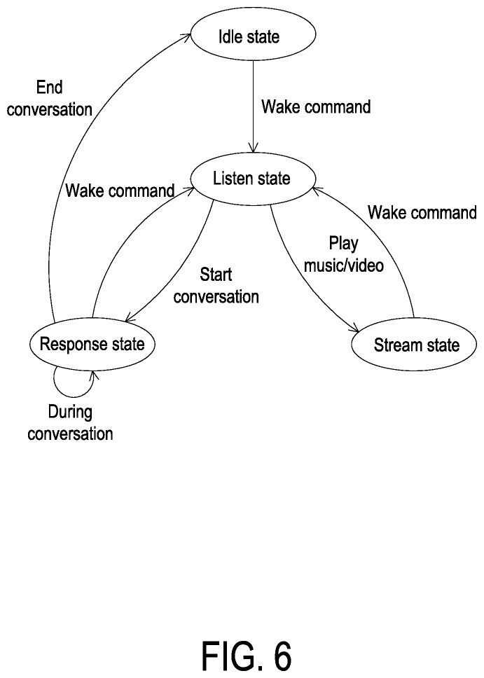

Please refer to FIG. 4 and FIG. 6. FIG. 6 schematically illustrates the operation states of an arbitrator of a control method of multi voice assistants of the present invention. As shown in FIG. 4 and FIG. 6, the arbitrator 121 utilized by the control method of multi voice assistants of the present invention is operated in one of the idle state, the listen state, a stream state and a response state. In the very beginning of the flow chart, which is the step S10, the arbitrator 121 is operated in the idle state. In the step S20, the arbitrator 121 enters the listen state from the idle state. In the step S30, the arbitrator 121 analyzes the voice object inputted by the listener 122 according to the recognition policy 123 to obtain the analysis result, and further select the corresponded recognition engine. In the step S40, the arbitrator 121 enters the response state. If the judgment determines that the conversation is over, the arbitrator 121 will enter the idle state. If the judgment determines that the conversation is not over (i.e. during the conversation), the arbitrator 121 will maintain the response state till the conversation is over and enter the idle state or switch to another state according to another wake command received. In specific, when the arbitrator 121 is operated in the idle state, the listen state or the stream state, the recognition engines are activated. When the arbitrator 121 is operated in the response state, the corresponded recognition engine selected in the step S30 is enabled, and the rest of the recognition engines are disabled. In other words, when the arbitrator 121 is operated in the response state, only the corresponded recognition engine that is selected will work. The electronic device 1 is in a state of focusing on responding the user with the corresponded recognition engine and the corresponded voice assistant. At this time, turning the rest of the voice assistants off may reduce the consumptions of the system resource and the power, and enhance the system efficiency in the same time.

Please refer to FIG. 5 and FIG. 6 again. In the control method of multi voice assistants of the present invention, the step S50 and the step S60 may be implemented through the following two manners. In some embodiments, in the step S50, the recognition threshold of the corresponded recognition engine is enabled, and the recognition thresholds of the rest of the recognition engines are disabled. For example, if the corresponded recognition engine that is selected in the step S30 is the first recognition engine 210, and the corresponded recognition threshold is the first recognition threshold 21, in the step S50, the first recognition threshold 21 is enabled, and the recognition threshold of the rest of the recognition engines, which is the second recognition threshold 22, is disabled, so that the first recognition engine 210 will work, and the second recognition engine 220 will not work. That is, the step S60 of turning off the non-corresponded recognition engines is implemented, in which the second recognition engine is turned off.

In some embodiments, in the step S50, the recognition threshold of the corresponded recognition engine is modified to be decreased, and the recognition thresholds of the rest of the recognition engines are modified to be increased. For example, if the corresponded recognition engine that is selected in the step S30 is the second recognition engine 220, and the corresponded recognition threshold is the second recognition threshold 22, in the step S50, the second recognition threshold 22 is modified by the arbitrator 121 to be decreased, so that it is easy to recognize. It can also be considered as lowering the recognition threshold to the threshold for activating recognition. The recognition threshold of the rest of the recognition engines, which is the first recognition threshold 21, is modified by the arbitrator 121 to be increased to a value that may be infinity or an extreme large value. It can also be considered as to increase the recognition threshold to a value that is much larger than the threshold that can be activated. That is, the step S60 of turning off the non-corresponded recognition engines is implemented, in which the first recognition engine is turned off.

The first recognition threshold 21 and the second recognition threshold 22 are further described below. The control of the first recognition threshold 21 and the second recognition threshold 22 may have different settings of the threshold according to the states of the conversation. For example, in the initial state, which is the idle state mentioned above, the first recognition threshold 21 and the second recognition threshold 22 may be set to work as long as hearing any keyword. In the states with a conversations, such as in the listen state and the response state, the first recognition threshold 21 and the second recognition threshold 22 may be set to determine whether to work according to the contents of the conversations. For example, if an utterance of a user includes “help me to call Oliver”, the keyword “Oliver” does not work in this utterance. If an utterance of the user includes “Alexa, help me to make a phone call”, the keyword “Alexa” does work in this utterance, and a corresponded recognition engine linked with this keyword will be activated. It should be noted that “work” mentioned here refers to whether the determination of the first recognition threshold 21 and the second recognition threshold 22 is effective but not refers to whether it works or not in the following conversations. In the following determination of the following conversations, another entity variable is defined to process the different parts.

In specific, the judgment of the content of a conversation is determined according to the entire context, and the content of the conversation is judged by the AI-like mode. The utterance is determined as including the intent and the entity variable. The embodiments mentioned above will be described again. If the user speaks “help me to call Oliver”, the intent is to “call” and the entity variable is “Oliver” in this utterance. In another utterance, the user speaks “Alexa, help me to make a phone call”. The intent is to “call”, but there is no entity variable in this utterance.

From the above description, the present invention provides a control method of multi voice assistants. By analyzing the voice object and directly selecting the corresponded recognition engine, the corresponded voice assistant can be directly called to provide service, so that the user may use the electronic device through more intuitive conversations, thereby enhancing the user experiences and reducing the wait time. Meanwhile, through the application of the arbitrator, the recognition policy and the listener, not only all the recognition engines can be early re-activated to recognize when the wait time is longer than a preset time, but also the corresponded recognition engine can be selected according to the content inputted from the listener to the arbitrator, so that the wait time of the user is reduced and the redundant conversation is avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method of multi voice assistants, comprising steps of:
(a) providing an electronic device equipped with a plurality of voice assistants;
(b) activating a plurality of recognition engines corresponded to the voice assistants for making the electronic device enter a listening mode to receive at least a voice object;
(c) analyzing the voice object and selecting a corresponded recognition engine from the recognition engines according to an analysis result;
(d) judging whether a conversation is over;
(e) modifying a plurality of recognition thresholds corresponded to the recognition engines; and
(f) turning off the non-corresponded recognition engines, wherein when the judgment of the step (d) is TRUE, the step (b) is performed after the step (d), and when the judgment of the step (d) is FALSE, the step (e) and the step (f) are sequentially performed after the step (d).

2. The control method of multi voice assistants according to claim 1 further comprising a step (d1), after the step (d), of judging whether a wait time for following commands is overdue, wherein when the judgment of the step (d) is FALSE, the step (d1), the step (e) and the step (f) are sequentially performed after the step (d).

3. The control method of multi voice assistants according to claim 2, wherein the electronic device comprises an arbitrator, and when the electronic device enters the listening mode in the step (b), the arbitrator enters a listen state from an idle state.

4. The control method of multi voice assistants according to claim 3, wherein the electronic device further includes a storage device and a listener, a recognition policy is preloaded by the storage device, and the arbitrator analyzes the voice object inputted by the listener according to the recognition policy to obtain the analysis result in the step (c).

5. The control method of multi voice assistants according to claim 4, wherein the judgment of the step (d) is judged by the arbitrator according to an input from the listener, and when the input is a notification of end of the conversation, the judgment of the step (d) is TRUE.

6. The control method of multi voice assistants according to claim 4, wherein the judgment of the step (d1) is judged by the arbitrator according to the recognition policy, and when the wait time is larger than a preset time preset in the recognition policy, the judgment of the step (d1) is TRUE.

7. The control method of multi voice assistants according to claim 3, wherein the arbitrator is operated in one of the idle state, the listen state, a stream state and a response state.

8. The control method of multi voice assistants according to claim 7, wherein when the arbitrator is operated in the idle state, the listen state or the stream state, all the recognition engines are activated, and when the arbitrator is operated in the response state, the corresponded recognition engine selected in the step (c) is enabled, and the rest of the recognition engines are disabled.

9. The control method of multi voice assistants according to claim 2, wherein when the judgment of the step (d1) is TRUE, the step (b) is performed after the step (d1), and when the judgment of the step (d1) is FALSE, the step (e) and the step (f) are performed after the step (d1).

10. The control method of multi voice assistants according to claim 1, wherein in the step (e), the recognition threshold of the corresponded recognition engine is enabled, and the recognition thresholds of the rest of the recognition engines are disabled.

11. The control method of multi voice assistants according to claim 1, wherein in the step (e), the recognition threshold of the corresponded recognition engine is modified to be decreased, and the recognition thresholds of the rest of the recognition engines are modified to be increased.
